(19) United States
(12) Patent Application Publication
(10) Pub. No.: US 2024/0209900 A1
(43) Pub. Date: Jun. 27, 2024

(54) STEERING COUPLING AND ARRANGEMENT RELATED THERETO

(71) Applicant: VANDEWIELE SWEDEN AB, ULRICEHAMN (SE)

(72) Inventor: Patrik MAGNUSSON, BORÅS (SE)

(21) Appl. No.: 18/555,756

(22) PCT Filed: Feb. 8, 2022
(86) PCT No.: PCT/SE2022/050134

§ 371 Date: Oct. 17, 2023

(30) Foreign Application Priority Data
Apr. 22, 2021 (SE) 2150503-7

(51) Int. Cl. F16D 3/12; B62D 5/04; F16D 3/06

(52) U.S. Cl. CPC F16D 3/12; B62D 5/046; F16D 3/06; F16D 2200/0056

(57) ABSTRACT

Described are, among other things, a steering coupling (50) for interconnecting a steering gear with a steering aid device is provided. The steering coupling comprises a first, outer, shaft (52) having a plurality of inward projecting teeth (53), and a second, inner, shaft (54) having a plurality of outward projecting teeth (55) in direct co-operation with the first outer shaft to form a steering coupling. The first shaft and the second shaft are configured to rotate together in both rotational directions around a common axle. The steering coupling also comprises at least one clastic pad (56), wherein the at least one clastic pad is provided in a pocket (58) of one of the shafts and where the at least one clastic pad abuts pocket side walls in both said rotational directions of the shaft in which the pocket is located. The at least one elastic pad also has a projection extending out from the pocket and wherein said projection abuts sides in both said rotational directions of the tooth/teeth of the shaft cooperating with the shaft provided with the pocket. Hereby the steering coupling can be assembled such that no, or a significantly reduced, play can be achieved in the steering coupling. The steering coupling can then be aided by a steering aid device such as an electrical motor without causing oscillation in the steering aid device and thereby improve power efficiency and reduce wear on the steering aid device. Also steering wheel vibrations can be eliminated, steering coupling and arrangement related thereto

### TECHNICAL FIELD

The present disclosure relates to a steering coupling and also to an arrangement for active steering.

### BACKGROUND

Steering devices and in particular steering devices used in active steering systems for motor vehicles are generally designed with a play between the teeth of steering coupling. This can cause different problems as is described in US20040154422.

Further, conventional active steering systems are typically provided with an electric motor providing an assisting steering force. The electric motor is controlled by a controller in response to different input parameters. To enable an accurate steering assistance with a good “feel” for the driver, the electrical motor will typically be controlled by a control system operating with high gain and at a high frequency. Such conventional active steering systems are described in e.g., EP1982896 and EP2448805.

Further, JP 20091088892 describes a steering coupling with an elastic member in the spline hole.

There is a constant desire to improve steering couplings and the performance of active steering arrangements.

### SUMMARY

It is an object of the present invention to provide an improved steering coupling and in particular a steering coupling suitable for an active steering arrangement. It is also an object of the present invention to provide an improved active steering arrangement.

This object and/or others are obtained by the steering coupling and the steering coupling arrangement as set out in the appended claims.

As has been realized, when utilizing an electric motor in an active steering arrangement for a vehicle, the electric motor needs to operate under control of a control system having a high gain and operating at a high frequency to output a desired feel in the steering arrangement using the electric motor to provide the assisting torque. Further, as is known, there needs to be a play in the coupling when assembling the steering coupling. Thus, while in many assemblies it is possible to tighten the outer shaft, this is not possible when putting together a steering coupling. Here it is necessary to push the shafts together (requiring some play) and then the shaft coupling can not be tightened but the play will remain.

As has been further realized, the combination of an electrical motor for providing an assisting torque operating with high speed and at a high frequency with the necessary play in the steering coupling can cause problems. Thus, when the vehicle is driven so that no assisting torque is required (typically when the vehicle is driven straight forward, or straight backward), the play in the steering coupling can cause the electrical motor to oscillate back and forth. The oscillation will cause the electrical motor to consume power and will wear the electrical motor and also the parts of the steering coupling. In addition, vibrations can be felt in the steering wheel by the driver. These problems could be reduced by providing less gain in the control of the electrical motor providing the assisting torque or reducing the frequency of the electrical motor control. However, that would give negative consequences to the steering and the steering feel.

In accordance with the present invention, a steering coupling for connecting a steering gear with a steering aid device is provided. The steering coupling comprises a first, outer, shaft having a plurality of inward projecting teeth, and a second, inner, shaft having a plurality of outward projecting teeth in direct co-operation with the first outer shaft to form a steering coupling that can transfer a high torque with a good security margin. The first shaft and the second shaft are configured to rotate together in both rotational directions around a common axis. The steering coupling also comprises at least one elastic pad, wherein the at least one elastic pad is provided in a pocket of one of the shafts and where the at least one elastic pad abuts pocket side walls in both said rotational directions of the shaft in which the pocket is located. The at least one elastic pad also has a projection extending out from the pocket and wherein said projection abuts sides in both said rotational directions of the tooth/teeth of the shaft cooperating with the shaft provided with the pocket. Hereby the steering coupling can be assembled such that no, or a significantly reduced, play can be achieved in the steering coupling. The steering coupling can then be aided by a steering aid device such as an electrical motor without causing oscillation in the steering aid device and thereby improve power efficiency and reduce wear on the steering aid device. Also, steering wheel vibrations and noise in the steering coupling can be eliminated and at the same time a direct power transfer between the inner shaft splines and outer shaft splines can be obtained whereby the direct power transfer is maintained. Thus, vibrations can be eliminated by use of the elastic pad(s). The pads remove the play between the splines. At the same time, the direct power transfer between the metal splines is not removed. Thus, when torque is transferred between the splines this is performed by metal in contact with metal whereby a firm power transfer is provided.

In accordance with some embodiments, a plurality of elastic pads is provided in a corresponding number of pockets. Hereby an improved connection between the cooperating shafts of the steering coupling can be achieved.

In accordance with some embodiments, the teeth of the shafts are formed as splines to form a spline coupling. Hereby the elastic pads can be made to abut only a part of the teeth of the shaft making the steering coupling stronger and more robust.

In accordance with some embodiments, the at least one elastic pad is made of an elastomer material or a rubber material. Hereby an efficient and wear resistant pad can be implemented. The rubber or elastomer, due to its hysteresis properties, will also act to damp any vibrations which is beneficial if the electrical motor of the steering aid tends to enter an oscillation state of operation.

In accordance with one embodiment, the at least one elastic pad is press fit into the pocket and the at least one elastic pad is press fit against the teeth of the shaft cooperating with the shaft provided with the pocket. Hereby the elastic pads can be securely fitted in the steering coupling and eliminate, for all practical purposes, the play in the steering coupling.

In accordance with some embodiments, the elastic pads can have some extension in the axial direction of the teeth of the shafts, but only extend over a part of the axial length of the teeth of the shafts in the steering coupling. Hereby a stronger connection can be achieved in that the teeth can engage by metal-to-metal contact over a larger area.

In accordance with some embodiments, the pocket(s) holding said at least one elastic pad is located at an end section of the shaft in which the pocket(s) are located. Hereby assembly of the steering coupling with the elastic pads can be facilitated.

In accordance with some embodiments, the at least one elastic pad is formed by a solid material. Hereby the elastic pads will have a firm constitution that can withstand the forces in the steering coupling.

In accordance with some embodiments, the at least one elastic pad has a plurality of projections that match the shape of a tooth or teeth of the shaft cooperating with the shaft provided with the pocket. Hereby a secure fitting between the elastic pads and the teeth can be obtained.

In accordance with some embodiments, when a plurality of elastic pads is provided, the plurality of elastic pads is connected together by a connection part. Hereby an easy assembly of the steering coupling can be achieved. The connection part and the elastic pads can be formed/manufactured as one integral element. The connection part can have an annular shape. Further one shaft can be provided with a recess at the end section and the connection part can be located in the recess.

In accordance with some embodiments, the recess has an undercut section shaped to prevent the connection part from moving in an axial direction of the shaft with the recess. Hereby the elastic pads can be securely held in place even when the elastic pads are located at an end section of the shaft.

The invention also extends to an active steering arrangement comprising the steering coupling according to the above that also comprises an electric motor connected to one of the shafts to provide assisting steering force to the steering of a vehicle. Hereby an energy efficient active steering arrangement can be obtained. The active steering arrangement can also comprise a control module connected to the electrical motor for control of the assisting steering force applied by the electrical motor.

In accordance with another aspect, the steering coupling and the active steering arrangement as described herein is used in an autonomous vehicle to improve the control of the autonomous vehicle. By reducing the risk for oscillation, the autonomous vehicle can be given a more robust steering control and thereby improve the steering control of the autonomous vehicle.

### BRIEF DESCRIPTION OF THE DRAWINGS

The present invention will now be described in more detail by way of non-limiting examples and with reference to the accompanying drawings, in which:

FIG. 1 is a general view illustrating a steering coupling arrangement,

FIG. 2 is a view of an active steering unit,

FIG. 3 is a view in perspective of a steering coupling,

FIG. 4 is a view of a shaft for a steering coupling with elastic pads in pockets,

FIG. 5 is a view of a shaft for a steering coupling with the elastic pads removed from the pockets, and

FIG. 6 is a view illustrating elastic pads.

### DETAILED DESCRIPTION

In the following an active steering arrangement and parts thereof will be described. In the Figures, the same reference numerals designate identical or corresponding elements throughout the several Figures. It will be appreciated that these figures are for illustration only and are not in any way restricting the scope of the invention. Also, it is possible to combine features from different described embodiments to meet specific implementation needs. Some components can be omitted in some embodiments.

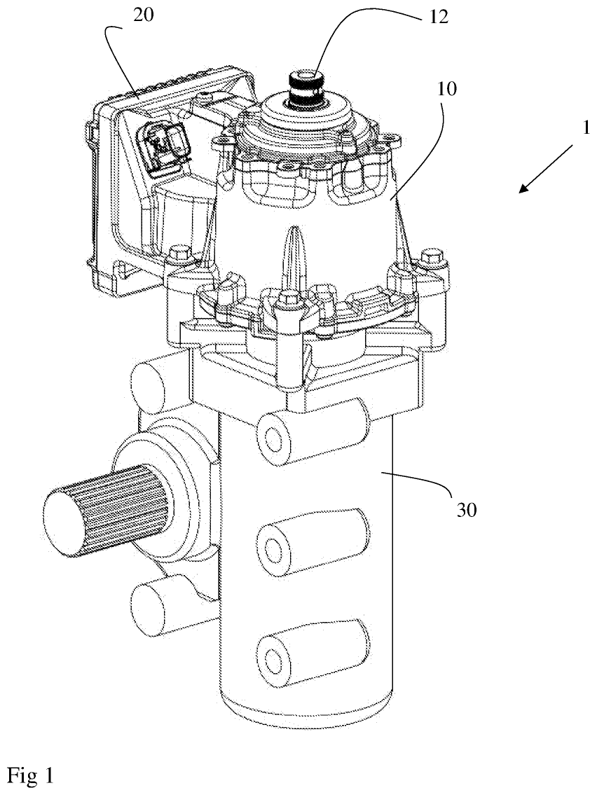

In FIG. 1, a general view of a conventional steering coupling arrangement 1 is shown. The steering coupling arrangement comprises an active steering unit 10. The active steering unit 10 can typically comprise a motorized steering aid to make steering easier for the driver. The motorized steering aid can typically be implemented by an electrical motor that is configured to deliver an assisting torque. The motorized steering aid device can be controlled by a control module 20 in a manner known per se. The exemplary active steering unit 10 is in a first, upper, end 12 connectable to a steering column and in a second lower end connected to a steering gear 30. However, other components can in some embodiments be connected between the steering column of a vehicle and the steering gear 30 of the vehicle.

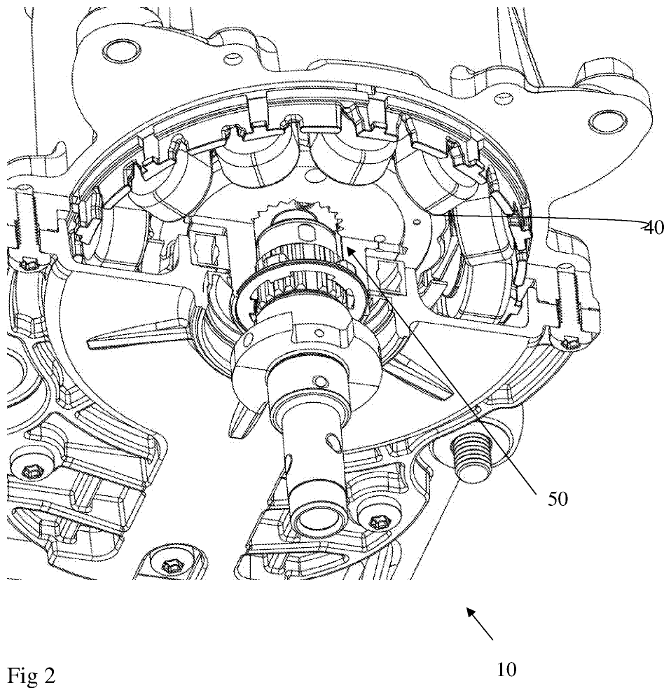

In FIG. 2 the active steering unit 10 is shown in a partial cross-sectional view in perspective. The active steering unit 10 comprises an electrical motor 40. The electrical motor is configured to operate as a steering aid device by rotating a shaft of a steering coupling 50 located in the active steering unit 10 to aid the driver in steering the vehicle. It is also envisaged that the active steering unit 10 can be used in an autonomous vehicle.

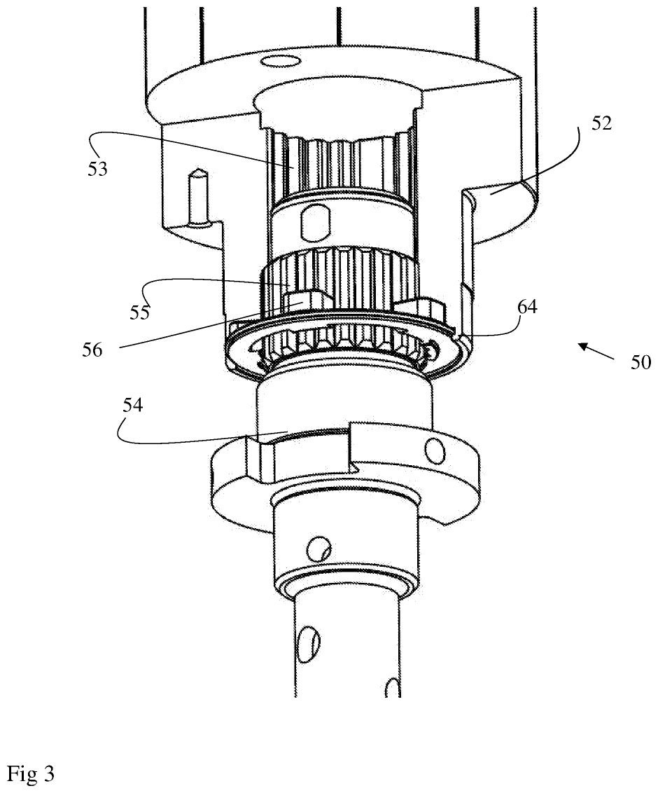

In FIG. 3 the steering coupling 50 is shown in more detail as a partial cross-sectional view in perspective. The steering coupling 50 comprises a first, outer, shaft 52 having a plurality of inward projecting teeth 53. The outer shaft can in some embodiments be rotated by the electrical motor 40 or, as is shown in FIG. 2, the rotor of the electrical motor can form the outer shaft with the inward projecting teeth 53. The steering coupling 50 further comprises a second, inner, shaft 54 having a plurality of outward projecting teeth 55 co-operating with the teeth 53 of the first outer shaft 52 to form the steering coupling 50. The co-operating teeth of the outer shaft 52 and the inner shaft 54 form a robust connection that can transfer the steering power from the outer shaft 52 to the inner shaft 54. The teeth 53, 55 of the outer shaft 52 and the inner shaft 54 can be configured in a suitable manner that enables the transfer of power in the steering coupling 50. Thus, as is seen in FIG. 3, the teeth 53, 55 of the outer shaft 52 and the inner shaft 54 are in direct contact whereby the robust power transfer is made possible. Hereby, almost all the power is transferred via the teeth 53, 55 in the coupling when the steering coupling is operated. In accordance with some embodiments at least 50% or preferably more such as at least 80 or 90% is transferred via the teeth 53, 55 when operating the steering coupling. This is advantageous because the teeth 53, 55, which are typically made of metal or some other hard material can provide a firm and robust power transfer. At the same time the pads can remove play in the steering coupling whereby vibrations and noise can be reduced or even eliminated.

Typically, the teeth 53, 55 of the shafts 52, 54 can be arranged as splines or some similar configuration where the teeth are elongated in the axial direction of the outer shaft 52 and the inner shaft 54. Thus, the teeth can be arranged as shaft splines (or serrations) that form ridges, or teeth type keys that are an integral part of one shaft that mesh with grooves in a mating shaft to transfer torque and rotational motion. The outer shaft 52 and the inner shaft 54 of the steering coupling 50 are therefore configured to rotate together in both rotational directions around a common axis.

The steering coupling 50 further comprises at least one elastic pad 56. The elastic pad 56 is provided in a pocket 58 of one of the inner shaft 54 or the outer shaft 52. The elastic pad 56 abuts pocket side walls in both rotational directions of the shaft in which the pocket is located. The elastic pad 56 has a projection extending out from the pocket. The projection abuts sides in both said rotational directions of a tooth or teeth of the shaft cooperating with the shaft provided with the pocket.

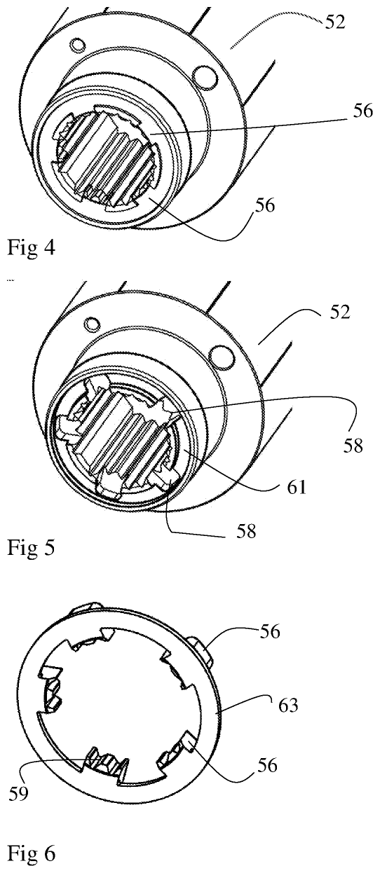

The elastic pad 56 will now be described in more detail with reference to FIGS. 4, 5 and 6. In FIG. 4, a plurality of elastic pads 56 are shown placed in pockets 58 of an outer shaft 52 in accordance with one exemplary embodiment. In the embodiment of FIG. 4, the pockets 58 are formed as cavities in one of the shafts to allow the matching shaft with its splines to contact splines of the shaft with the cavities. Thus, when the pad(s) 56 are placed in the pockets 58 the teeth (splines) of the steering coupling can still contact each other when the steering coupling is operated. The cavities can typically be designed with no element that protrudes over the teeth (spline) cross section. The pockets 58 can advantageously have distinct walls so the elastic pads can be fitted with good and defined support on its tangential sides, ensuring a play free joint between the side of the pockets and the teeth (splines) of the matching shaft. Thus, the pockets 58 can be formed with sides being perpendicular to the tangential direction of the circumference of the inner or outer shaft. Thus, when the shaft where the pocket is located is rotated the pocket will provide good support since the plane pocket side is perpendicular to the rotation direction of the shaft.

However, as set out above, it is also envisaged that the pockets are located in the inner shaft 54. The elastic pads 56 are made of a material more elastic than the shafts 52, 54. The elastic pads 56 can advantageously be made of rubber or an elastomer whereas the shafts 52, 54 are typically made of a metal material or a material comprising a metal. The elastic pads 56 can advantageously be press fitted in the pockets 58. The elastic pads 56 have projections 59 (best seen in FIG. 6) facing inwards towards where the inner shaft is to be located. The projections 59 can be formed to match the teeth of the other shaft of the steering coupling 50, in this exemplary embodiment the inner shaft 54. The projections 59 can be formed in many different ways. For example, in the embodiment shown in FIGS. 4 and 6, multiple projections 59 are formed on each pad 56. However, it is also envisaged that the projections 59 can be simpler and only match a recess between two teeth of the inner shaft. In another embodiment the projection 59 of an elastic pad 56 can be formed to abut one single tooth in the inner shaft from both sides of the tooth.

The elastic pad 56 can advantageously be press fitted against the tooth/teeth of the other shaft of the steering coupling. Hereby a very firm and robust assembly can be provided where the play between the shafts 52, 54 of the steering coupling can be significantly reduced or even eliminated.

In FIG. 5 the outer shaft 52 is shown with the elastic pads removed. As is shown the outer shaft 52 is provided with pockets 58 as described above. When the pockets 58 are located at an end section of one of the inner or outer shafts 52, 54 a recess 61 can be provided at the end of the shaft where the pockets 58 are located. The purpose of the recess 61 is to make space for a connection part as will be described below in conjunction with FIG. 6.

In FIG. 6 a plurality of elastic pads 56 are shown connected by a connection part 63. By connecting a plurality of elastic pads 56, assembly of the elastic pads 56 in the pockets 58 is facilitated and the pads can be better secured. The connection part 63 can be any suitable shape such as circular or polygonal. The connection part 63 can be located in the recess 61 and the recess 61 can be shaped to receive the connection part 63. In FIG. 6 the connection part is annular and has five elastic pads 56 attached thereto. There can be more or fewer elastic pads 56 attached to the connection part depending on the specific implementation. The connection part 63 and the plurality of elastic pads 56 can be formed as one integral element. By forming the plurality of elastic pads 56 in one integral element, the manufacture of the plurality of elastic pads 56 is facilitated. Also, handling of the elastic pads 56 before and during assembly is made easier since the plurality of elastic pads held together by the connection part 63 will be larger and more user-friendly to pick up and put in place. FIG. 6 also shows the projections 59 of the elastic pads. Here each projection 59 has three projecting parts, but as set out above other designs of the projections are possible to make the projection 59 abut the tooth/teeth of the mating shaft.

Further, to prevent the pads 56 from moving in an axial direction of the shaft an undercut section 64 can be formed in the recess 61. This is best seen in FIG. 3 where an undercut section 64 is shown. Hereby the elastic pads 56 attached to the connection part 61 will be held in place since the connection part 61 is stopped from moving in an axial direction by the undercut section 64. In an alternative embodiment or as a supplement an undercut can be made in the pocket/pockets 58.

By providing elastic pads 56 in pockets 58 of one of the shafts in a steering coupling as described herein, the play in the steering coupling can be practically eliminated. Hereby oscillation in an electrical motor used to provide an additional steering torque in an active steering system can be eliminated and less power needs to be used by the electrical motor. Also, the wear on the electrical motor is reduced resulting in an increased life time for the electrical motor. The lifetime for the steering coupling will increase due to less wear on the steering coupling and the driver will get a better feel when steering the vehicle.

It is advantageous if the elastic pads are solid, i.e., without any holes or cavities inside because the elastic pads will then rest firmly in the pockets and the projections can make good contact with teeth of the co-operating shaft and be stiff enough to withstand the oscillation.

The elastic pads 56 can advantageously be located at an end section of one of the shafts 52, 54 of the steering coupling. The elastic pads 56 can have some extension in the axial direction of the teeth of the shafts, but preferably only extend over a part of the axial length of the teeth 53, 55 of the shafts in the steering coupling. For example, the elastic pads 56 can extend 5-50% of the axial length of the teeth 53, 55 of the shafts 52, 54. In accordance with one preferred embodiment the elastic pads 56 extend only 5-25% of the axial length of the teeth 53, 55 of the shafts 52, 54 whereby assembly is made easier and the steering coupling can be made stronger by more metal-to-metal contact.

The steering coupling and the active steering arrangement as described herein is used in an autonomous vehicle to improve the control of the autonomous vehicle. By reducing the risk for oscillation, the autonomous vehicle can be given a more robust steering control and thereby improve the steering control of the autonomous vehicle.

1. Steering coupling for connecting a steering gear and a steering aid device comprising:
a first, outer, shaft having a plurality of inward projecting teeth,
a second, inner, shaft having a plurality of outward projecting teeth in direct cooperation with the first outer shaft to form a steering coupling,
the first shaft and the second shaft being configured to rotate together in both rotational directions around a common axis, and
at least one elastic pad,
wherein the at least one elastic pad is provided in a pocket of one of the shafts and where the at least one elastic pad abuts pocket side walls in both said rotational directions of the shaft in which the pocket is located, and wherein the at least one elastic pad has a projection extending out from the pocket and wherein said projection abuts sides in both said rotational directions of a tooth or teeth of the shaft cooperating with the shaft provided with the pocket.

2. The steering coupling according to claim 1 wherein a plurality of elastic pads is provided in a corresponding number of pockets.

3. The steering coupling according to claim 1, wherein the teeth of the shafts are formed as splines to form a spline coupling.

4. The steering coupling according to claim 1, wherein the at least one elastic pad is made of an elastomer material or a rubber material.

5. The steering coupling according to claim 1, wherein the at least one elastic pad is press fit into the pocket and wherein the at least one elastic pad is press fit against the teeth of the shaft cooperating with the shaft provided with the pocket.

6. The steering coupling according to claim 1, wherein the elastic pads only extend over a part of the axial length of the teeth of the shafts in the steering coupling.

7. The steering coupling according to claim 1, wherein the pocket(s) holding said at least one elastic pad is located at an end section of the shaft in which the pocket(s) are located.

8. The steering coupling according to claim 1, wherein the at least one elastic pad is formed by a solid material.

9. The steering coupling according to claim 1, wherein the at least one elastic pad has a projection with projecting parts that match the shape of a tooth or teeth of the shaft cooperating with the shaft provided with the pocket.

10. The steering coupling according to claim 1, when a plurality of elastic pads is provided, wherein the plurality of elastic pads is connected together by a connection part.

11. The steering coupling according to claim 10, wherein the connection part and the elastic pads are formed as one integral element.

12. The steering coupling according to claim 10, wherein the connection part has an annular shape.

13. The steering coupling according to claim 10, wherein one shaft is provided with a recess at the end section and wherein the connection part is located in said recess.

14. The steering coupling according to claim 13, wherein the recess has an undercut section shaped to prevent the connection part from moving in an axial direction of the shaft with the recess.

15. An active steering arrangement comprising the steering coupling according to claim 1 and further comprising an electric motor connected to one of the shafts to provide assisting steering force to the steering of a vehicle.

16. The active steering arrangement according to claim 15, further comprising a control module connected to the electrical motor for control of the assisting steering force applied by the electrical motor.

17. An autonomous vehicle comprising the steering coupling according to claim 1 or an active steering arrangement.
